(19) United States
(12) Patent Application Publication
(10) Pub. No.: US 2006/0246331 A1
(43) Pub. Date: Nov. 2, 2006

(54) Partitioned fuel cell stacks and fuel cell systems including the same

(76) Inventor: Matthew P. Steinbroner, Bend, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/150,615

(22) Filed: Jun. 10, 2005

Related U.S. Application Data
(60) Provisional application No. 60/675,978, filed on Apr. 29, 2005.

(51) Int. Cl. H01M 8/04; H01M 8/24

(52) U.S. Cl. 429/23; 429/38; 429/37

(57) ABSTRACT

Partitioned fuel cell stacks having end plates between which two or more subassemblies of fluidly interconnected fuel cells are supported and selectively electrically isolated from each other. At least the fuel cells in each subassembly, and optionally all of the stack's fuel cells, are in fluid communication with each other. The stacks further include at least one partition that provides a non-conductive barrier between subassemblies within the stack. In some embodiments, a jumper is connected across a partition to electrically interconnect the subassemblies that are separated by the partition. In some embodiments, an electrical connection across the partition is provided by the jumper responsive to a switch. Responsive to the presence or absence of the jumper and/or the configuration of a switch, the partitioned stack provides a power output having a nominal voltage selected from a predetermined number of nominal voltages that the stack is adapted to selectively provide.

### RELATED APPLICATION

The present application claims priority to similarly entitled U.S. Provisional Patent Application Ser. No. 60/675,978, which was filed on Apr. 29, 2005 and the complete disclosure of which is hereby incorporated by reference for all purposes.

### FIELD OF THE DISCLOSURE

The present disclosure is directed generally to fuel cell stacks and fuel cell systems that include the same, and more particularly to fuel cell stacks that are adapted to selectively provide power outputs at a plurality of predetermined nominal voltages.

### BACKGROUND OF THE DISCLOSURE

Fuel cell stacks are electrochemical devices that produce an electric current from a fuel, which typically is a proton source, and an oxidant. Many conventional fuel cell stacks utilize hydrogen gas as the proton source and oxygen, air, or oxygen-enriched air as the oxidant. Fuel cell stacks typically include many fuels cells that are fluidly and electrically coupled together between common end plates. Each fuel cell includes anode and cathode regions that are separated by an electrolytic membrane. Hydrogen gas is delivered to the anode region, and oxygen gas is delivered to the cathode region. Protons from the hydrogen gas are drawn through the electrolytic membrane to the cathode region, where water is formed. Conventionally, the anode and cathode regions are periodically purged to remove water and accumulated gases in the regions. While protons may pass through the membranes, electrons cannot. Instead, the liberated electrons travel through an external circuit to form an electric current.

A fuel cell stack is a group of fuel cells that are coupled together as a unit between common end plates. The fuel cell stack includes manifolds and other delivery conduits to deliver and remove fluids to and from the fuel cells that are supported between the end plates. Conventionally, a fuel cell stack includes current collectors proximate each end of the stack. The current collectors are electrically connected to an external load, and power produced by the fuel cell stack is used to satisfy the external load. The fuel cell stack provides power having a predetermined nominal voltage. When a power output is required that has a different nominal voltage, power management devices must be used to convert the produced power output to the desired nominal voltage. For example, the DC power output produced by the stack may be modulated (bucked or boosted) to lower or raise the voltage of the power output. As another example, the DC power output from the stack may be converted to an AC power output. Portions of this power output, after production by the entirety of the operating cells in the stack, may be converted to a different voltage and/or current type than other portions, such as for use to satisfy a different load. However, regardless of this regulation and/or conversion, the fuel cell stack is still adapted to produce a power output having a single predetermined nominal voltage, which thereafter must be modulated or otherwise converted depending upon the desired application of the produced power output. This conversion of the power output requires additional components and may reduce the efficiency of the fuel cell system. For example, many conventional fuel cell systems are adapted to convert the entirety of the produced power output to AC, when the primary function of the fuel cell system is to provide power for an energy-consuming device that requires an AC power source, and then convert a portion of this AC power output back to DC power, such as to satisfy the balance-of-plant energy requirements of the fuel cell system and associated devices.

### SUMMARY OF THE DISCLOSURE

The present disclosure is directed to partitioned fuel cell stacks having two or more subassemblies of fuel cells that are selectively electrically isolated from each other or electrically connected to each other, and to fuel cell systems that include the same. The fuel cell stacks include a plurality of fuel cells that are supported between common end plates. At least the fuel cells in each subassembly, and in some embodiments all of the fuel cells in the fuel cell stack, are in fluid communication with each other, such as for the delivery of fuel and oxidant and/or the removal of water and excess fuel and/or oxidant. The fuel cell stacks further include at least one partition that provides a non-conductive barrier between subassemblies of fuel cells within the stack. The fuel cell stack includes current collectors associated with each end of the fuel cell stack, as well as current collectors associated with each side of the one or more partitions. In some embodiments, a jumper is connected across a partition to electrically interconnect the subassemblies that are separated by the partition. In some embodiments, an electrical connection across the partition is provided by the jumper responsive to the configuration of a switch, such as a manual or automated switch. Responsive to the presence or absence of the jumper and/or the configuration of a switch associated with the jumper, the partitioned fuel cell stack provides a power output having a nominal voltage selected from a predetermined number of nominal voltages that the stack is adapted to selectively provide.

### BRIEF DESCRIPTION OF THE DRAWINGS

FIG. 1 is a schematic view of an illustrative fuel cell system that includes a partitioned fuel cell stack according to the present disclosure.

FIG. 2 is a schematic view of an illustrative fuel cell, such as may be included in a partitioned fuel cell stack according to the present disclosure.

FIG. 3 is a schematic fragmentary view of a plurality of fuel cells, as may be used in partitioned fuel cell stacks according to the present disclosure.

FIG. 4 is an exploded schematic view of a fuel cell, as may be used in partitioned fuel cell stacks according to the present disclosure.

FIG. 5 is a schematic side elevation view of a partitioned fuel cell stack according to the present disclosure.

FIG. 6 is a schematic side elevation view of another partitioned fuel cell stack according to the present disclosure.

FIG. 7 is a schematic side elevation view of another partitioned fuel cell stack according to the present disclosure.

FIG. 8 is a schematic side elevation view of another partitioned fuel cell stack according to the present disclosure.

FIG. 9 is an elevation view of an illustrative construction for a partition for a partitioned fuel cell stack according to the present disclosure.

FIG. 10 is an elevation view of another illustrative construction for a partition for a partitioned fuel cell stack according to the present disclosure.

FIG. 11 is an elevation view of another illustrative construction for a partition for a partitioned fuel cell stack according to the present disclosure.

FIG. 12 is an elevation view of another illustrative construction for a partition for a partitioned fuel cell stack according to the present disclosure.

FIG. 13 is an elevation view of another illustrative construction for a partition for a partitioned fuel cell stack according to the present disclosure.

FIG. 14 is a fragmentary schematic side elevation view of a portion of a partitioned fuel cell stack according to the present disclosure.

FIG. 15 is a fragmentary schematic side elevation view of a portion of another partitioned fuel cell stack according to the present disclosure.

FIG. 16 is a schematic side elevation view of another partitioned fuel cell stack according to the present disclosure.

FIG. 17 is a schematic side elevation view of another partitioned fuel cell stack according to the present disclosure.

FIG. 18 is a schematic side elevation view of a housing for a partitioned fuel cell stack according to the present disclosure.

FIG. 19 is a schematic side elevation view of a housing for a partitioned fuel cell stack according to the present disclosure.

FIG. 20 is a schematic view of another illustrative fuel cell system that includes a partitioned fuel cell stack according to the present disclosure.

FIG. 21 is a schematic view of an illustrative hydrogen generation assembly that may be used with fuel cell systems that include a partitioned fuel cell stack according to the present disclosure.

FIG. 22 is a schematic view of another illustrative hydrogen generation assembly that may be used with fuel cell systems that include a partitioned fuel cell stack according to the present disclosure.

FIG. 23 is a schematic view of another illustrative hydrogen generation assembly that may be used with fuel cell systems that include a partitioned fuel cell stack according to the present disclosure.

### DETAILED DESCRIPTION AND BEST MODE OF THE DISCLOSURE

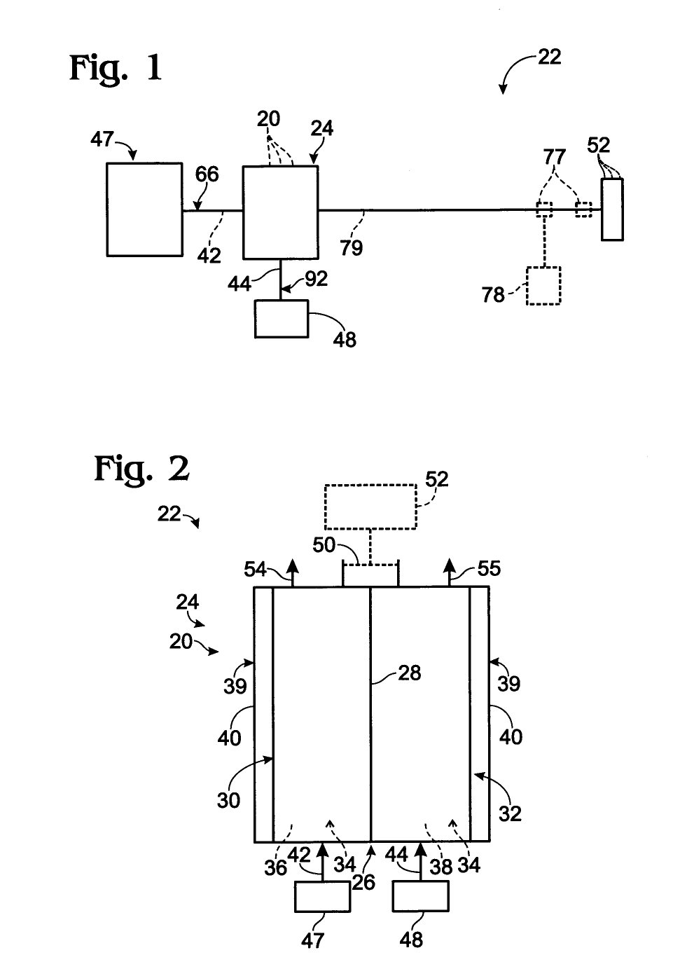

An example of a fuel cell system is schematically illustrated in FIG. 1 and generally indicated at 22. As discussed in more detail herein, system 22 includes at least one partitioned fuel cell stack 24 that is adapted to selectively provide a power output having a nominal voltage selected from a discrete number of predetermined nominal voltages that the partitioned fuel cell stack is adapted to selectively provide. Fuel 42 is any suitable reactant, or feedstock, for producing an electric current in a fuel cell stack when the fuel is and an oxidant are delivered to the anode and cathode regions, respectively, of the fuel cells in the stack. Fuel 42 may, but is not required to be, a proton source. In the following discussion, fuel 42 will be described as being hydrogen gas, and oxidant 44 will be described as being air, but it is within the scope of the present disclosure that other suitable fuels and/or oxidants may be used to produce a power output 79 in fuel cell stack 24. For example, other suitable oxidants include oxygen-enriched air streams, and streams of pure or substantially pure oxygen gas. Fuel cell system 22 may also be referred to as an energy-producing system. Illustrative examples of suitable fuels include methanol, methane, and carbon monoxide.

As schematically illustrated in FIG. 1, system 22 includes a source, or supply, 47 of hydrogen gas (or other fuel) and an air (or other oxidant) source, or supply, 48. The sources are adapted to deliver hydrogen and air streams 66 and 92 to the partitioned fuel cell stack 24. Hydrogen 42 and oxygen 44 may be delivered to the fuel cell stack via any suitable mechanism from sources 47 and 48. Stack 24 produces from these streams a power output, which is schematically represented at 79. Also shown in dashed lines in FIG. 1 is at least one energy-consuming device 52. Device 52 graphically represents one or more device that is adapted to apply a load to the fuel cell system, with the system being adapted to satisfy this load with the power output produced by the fuel cell stack. The energy-producing system may include additional components that are not specifically illustrated in the schematic figures, such as air delivery systems, heat exchangers, sensors, controllers, flow-regulating devices, fuel and/or feedstock delivery assemblies, heating assemblies, cooling assemblies, and the like.

The at least one energy-consuming device 52 may be electrically coupled to the energy-producing system 22, such as to the fuel cell stack 24 and/or one or more optional energy-storage devices 78 associated with the stack. Device 52 applies a load to the energy-producing system 22 and draws an electric current from the system to satisfy the load. This load may be referred to as an applied load, and may include thermal and/or electrical load(s). It is within the scope of the present disclosure that the applied load may be satisfied by the fuel cell stack, the energy-storage device, or both the fuel cell stack and the energy-storage device. Illustrative examples of devices 52 include motor vehicles, recreational vehicles, boats and other sea craft, and any combination of one or more households, residences, commercial offices or buildings, neighborhoods, tools, lights and lighting assemblies, appliances, computers, industrial equipment, signaling and communications equipment, radios, electrically powered components on boats, recreational vehicles or other vehicles, battery chargers and even the balance-of-plant electrical requirements for the energy-producing system 22 of which fuel cell stack 24 forms a part.

FIG. 1 schematically depicts that energy-producing system 22 may, but is not required to, include at least one energy-storage device 78. Device 78, when included, may be adapted to store at least a portion of the electrical output, or power, 79 from the fuel cell stack 24. An illustrative example of a suitable energy-storage device 78 is a battery, but others may be used. Illustrative, non-exclusive examples of other suitable energy-storage devices that may be used in place of or combination with one or more batteries include capacitors and ultracapacitors. Energy-storage device 78 may additionally or alternatively be used to power the energy-producing system 22 during start-up of the system. As indicated in dashed lines at 77 in FIG. 1, the energy-producing system may, but is not required to, include at least one power management module 77. Power management module 77 includes any suitable structure for conditioning or otherwise regulating the electricity produced by the energy-producing system, such as for delivery to energy-consuming device 52. Module 77 may include such illustrative structure as buck or boost converters, inverters, power filters, and the like.

The partitioned fuel cell stacks of the present disclosure may utilize any suitable type of fuel cell, and preferably fuel cells that receive hydrogen and oxygen as proton sources and oxidants. Illustrative examples of types of fuel cells include proton exchange membrane (PEM) fuel cells, alkaline fuel cells, solid oxide fuel cells, molten carbonate fuel cells, phosphoric acid fuel cells, direct methanol fuel cells, and the like. For the purpose of illustration, an exemplary fuel cell 20 in the form of a PEM fuel cell is schematically illustrated in FIG. 2.

Proton exchange membrane fuel cells typically utilize a membrane-electrode assembly 26 consisting of an ion exchange, or electrolytic, membrane 28 located between an anode region 30 and a cathode region 32. Each region 30 and 32 includes an electrode 34, namely an anode 36 and a cathode 38, respectively. Each region 30 and 32 also includes a support 39, such as a supporting plate 40. Support 39 may form a portion of the bipolar plate assemblies that are discussed in more detail herein. The supporting plates 40 of fuel cells 20 carry the relative voltage potentials produced by the fuel cells.

In operation, hydrogen gas 42 from supply 47 is delivered to the anode region, and air 44 from supply 48 is delivered to the cathode region. Hydrogen and oxygen 44 may be delivered to the respective regions of the fuel cell via any suitable mechanism from respective sources 47 and 48. Examples of suitable sources 47 for hydrogen 42 include a pressurized tank, metal hydride bed or other suitable hydrogen storage device, a chemical hydride (such as a solution of sodium borohydride), and/or a fuel processor or other hydrogen generation assembly that produces a stream containing pure or at least substantially pure hydrogen gas from at least one feedstock. Examples of suitable sources 48 of oxygen 44 include a pressurized tank of oxygen, oxygen-enriched air, or air, or a fan, compressor, blower or other device for directing air to the cathode regions of the fuel cells in the stack.

Hydrogen and oxygen typically combine with one another via an oxidation-reduction reaction. Although membrane 28 restricts the passage of a hydrogen molecule, it will permit a hydrogen ion (proton) to pass through it, largely due to the ionic conductivity of the membrane. The free energy of the oxidation-reduction reaction drives the proton from the hydrogen gas through the ion exchange membrane. As membrane 28 also tends not to be electrically conductive, an external circuit 50 is the lowest energy path for the remaining electron, and is schematically illustrated in FIG. 2. In cathode region 32, electrons from the external circuit and protons from the membrane combine with oxygen to produce water and heat.

Also shown in FIG. 2 are an anode purge, or exhaust, stream 54, which may contain hydrogen gas, and a cathode air exhaust stream 55, which is typically at least partially, if not substantially, depleted of oxygen. Fuel cell stack 24 may include a common hydrogen (or other reactant) feed, air intake, and stack purge and exhaust streams, and accordingly will include suitable fluid conduits to deliver the associated streams to, and collect the streams from, the individual fuel cells. Similarly, any suitable mechanism may be used for selectively purging the regions.

In practice, partitioned fuel cell stack 24 will include a plurality of fuel cells with bipolar plate assemblies separating adjacent membrane-electrode assemblies. The bipolar plate assemblies essentially permit the free electron to pass from the anode region of a first cell to the cathode region of the adjacent cell via the bipolar plate assembly, thereby establishing an electrical potential through the stack that may be used to satisfy an applied load. This net flow of electrons produces an electric current that may be used to satisfy an applied load, such as from at least one of an energy-consuming device 52 and the energy-producing system 22.

FIG. 3 shows a schematic representation of a fragmentary portion of an illustrative partitioned fuel cell stack 24. As shown, the illustrated portion includes a plurality of fuel cells, including fuel cells 16′ and 16″. Fuel cell 16′ includes a membrane-electrode assembly (MEA) 56 positioned between a pair of bipolar plate assemblies 57, such as assemblies 58 and 60. Similarly, fuel cell 16″ includes an MEA 62 positioned between a pair of bipolar plate assemblies 57, such as bipolar plate assemblies 60 and 64. Therefore, bipolar plate assembly 60 is operatively interposed between adjacently situated MEAs 56 and 62. Additional fuel cells may be serially connected in similar fashion, wherein a bipolar plate may be operatively interposed between adjacent MEAs. The phrase “working cell” is used herein to describe fuel cells, such as cells 16′ and 16″, that are configured to produce electric current and typically include an MEA positioned between bipolar plate assemblies.

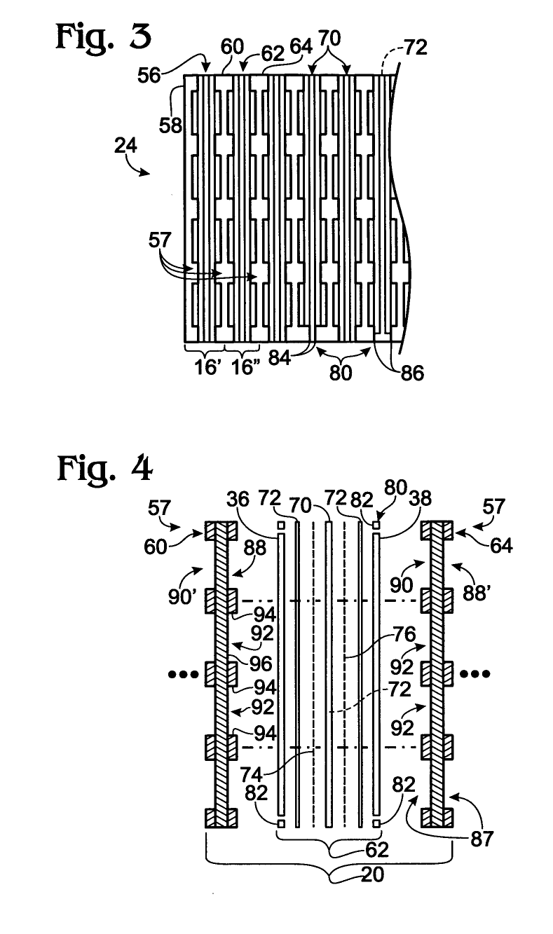

FIG. 4 shows an exploded schematic view of an illustrative fuel cell, or fuel cell assembly, 20, which as discussed includes a membrane-electrode assembly (MEA) 62 positioned between bipolar plate assemblies 60 and 64. MEA 62 includes anode 36, cathode 38, and an electron barrier 70 that is positioned therebetween. Electron barrier 70 may include any suitable structure and/or composition that enables protons to pass therethrough and yet retards the passage of electrons to bias the electrons to an external circuit. As an illustrative example, barrier 70 may include a membrane-supported electrolyte that is capable of blocking electrons, while allowing protons to pass. For example, in PEM fuel cells, electron barrier 70 may be a membrane that is configured to conduct hydrogen cations (protons) and inhibit electron flow, and as such may also be described as an ion exchange membrane. In an alkaline fuel cell, electron barrier 70 may include an aqueous alkaline solution or membrane. For phosphoric acid fuel cells, electron barrier 70 may include a phosphoric acid solution (neat or diluted) or membrane.

For at least PEM fuel cells, the electrodes, such as anode 36 and cathode 38, may be constructed of a porous, electrically conductive material such as carbon fiber paper, carbon fiber cloth, or other suitable materials. Catalysts 74 and 76 are schematically depicted as being disposed between the electrodes and the electron barrier. Such catalysts facilitate electrochemical activity and are typically embedded into barrier 70, such as into membrane 28. Cell 20 will typically also include a gas diffusion layer 72 between the electrodes and catalysts 74 and 76. For example, layer 72 may be formed on the surface of the electrodes and/or the catalysts and may be formed from a suitable gas diffusing material, such as a thin film of powdered carbon. Layer 72 is typically treated to be hydrophobic to resist the coating of the gas diffusion layers by water present in the anode and cathode regions, which may prevent gas from flowing therethrough. It should be understood that it is desirable to have a fluid seal between adjacent bipolar plate assemblies. As such, a variety of sealing materials or sealing mechanisms 80 may be used at or near the perimeters of the bipolar plate assemblies. An example of a suitable sealing mechanism 80 is a gasket 82 that extends between the outer perimeters of the bipolar plate assemblies and barrier 70. Other illustrative examples of suitable sealing mechanisms 80 are schematically illustrated in the lower portion of FIG. 3 and include bipolar plate assemblies with projecting flanges 84, which extend into contact with barrier 70, and/or a barrier 70 with projecting flanges 86 that extend into contact with the bipolar plate assemblies. In some embodiments, such as graphically depicted in FIG. 4, it may be desirable for the cells to include a compressible region between adjacent bipolar plate assemblies, with gaskets 82 and membranes 28 being examples of suitable compressible regions that permit the cells, and thus the stack, to be more tolerant and able to withstand external forces applied thereto.

As shown in FIG. 4, bipolar plate assemblies 60 and 64 extend along opposite sides of MEA 62 so as to provide structural support to the MEA. Such an arrangement also allows the bipolar plate assemblies to provide a current path between adjacently situated MEAs. Bipolar plate assemblies 60 and 64 are shown with flow fields 87, namely anode flow fields 88 and cathode flow fields 90. Flow field 88 is configured to transport fuel, such as hydrogen, to the anode. Similarly, flow field 90 is configured to transport oxidant, such as oxygen, to the cathode and to remove water and heat therefrom. The flow fields also provide conduits through which the exhaust or purge streams may be withdrawn from the fuel cell assemblies. The flow fields typically include one or more channels 92 that are at least partially defined by opposing sidewalls 94 and a bottom, or lower surface, 96. Flow fields 88 and 90 have been schematically illustrated in FIG. 4 and may have a variety of shapes and configurations. Similarly, the channels 92 in a given flow field may be continuous, discontinuous, or may contain a mix of continuous and discontinuous channels. Examples of a variety of flow field configurations are shown in U.S. Pat. Nos. 4,214,969, 5,300,370, and 5,879,826, the complete disclosures of which are herein incorporated by reference for all purposes.

As also shown in FIG. 4, the bipolar plate assemblies may include both anode and cathode flow fields, with the flow fields being generally opposed to each other on opposite faces of the bipolar plate assemblies. This construction enables a single bipolar plate assembly 57 to provide structural support and contain the flow fields for a pair of adjacent MEAs. For example, as illustrated in FIG. 4, bipolar plate assembly 60 includes anode flow field 88 and a cathode flow field 90′, and bipolar plate assembly 64 includes cathode flow field 90 and an anode flow field 88′. Although many, if not most or even all of the bipolar plate assemblies within a stack will have the same or a similar construction and application, it is within the scope of the disclosure that not every bipolar plate assembly within stack 24 contains the same structure, supports a pair of MEAs, or contains oppositely facing flow fields.

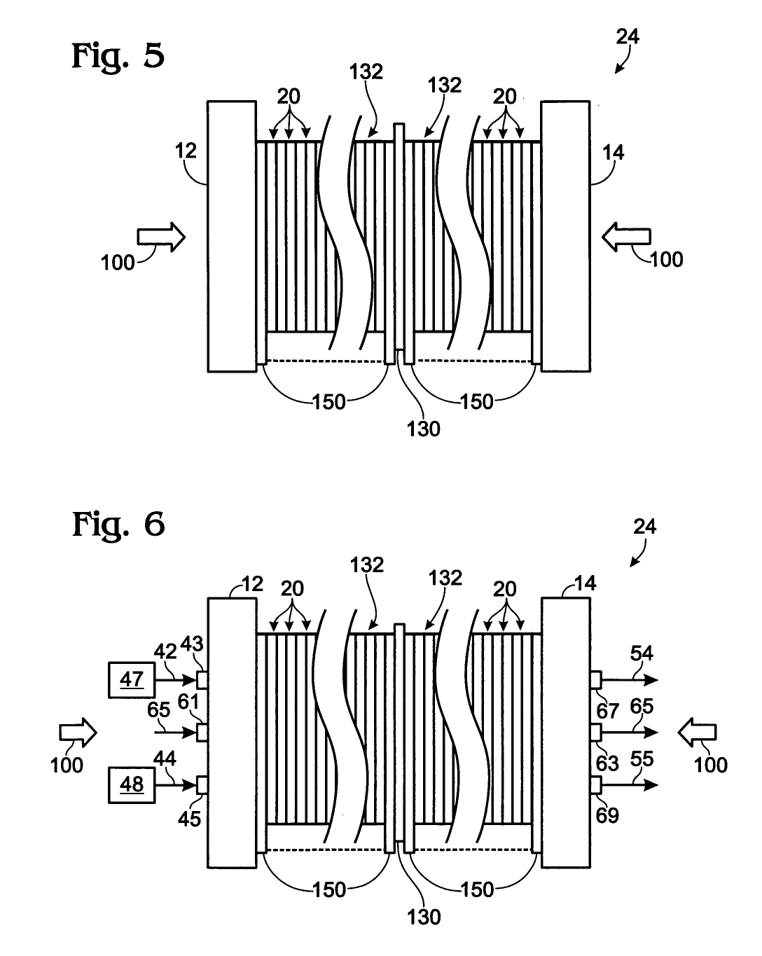

Somewhat less schematic examples of partitioned fuel cell stacks 24 according to the present disclosure is shown in FIGS. 5 and 6. As shown, stack 24 includes a plurality of fuel cells 20 supported between end plates 12 and 14. Each cell is individually configured to convert fuel and an oxidant into an electric current. The fuel cells are electrically coupled in series, although it is within the scope of the disclosure to couple the cells in parallel or in a combination of series and parallel. When electrically coupled, the cells collectively provide an electric potential dependent on the configuration of the stack. For example, if all cells of the fuel cell stack are electrically coupled in series, the electrical potential provided by the stack is the sum of the cells' respective potentials. Therefore, if each fuel cell produces 0.6 volts, then a stack having ten cells in series would have an output of 6 volts, a stack with 100 cells would have a power output of 60 volts, etc.

In the illustrated example shown in FIG. 6, the fuel cells of stack 24 are in fluid communication with each other, such that flows of fuel and oxidant may be delivered to the respective cells in the stack, and exhaust streams may be removed from the cells, via common delivery and exhaust manifolds. In the illustrative example shown in FIG. 6, the manifolds are shown being configured to deliver the fuel and oxidant streams 42 and 44 and to withdraw the anode and cathode exhaust streams 54 and 55 via ports associated with the end plates of the partitioned fuel cell stack. The streams of hydrogen and oxygen are received by the fuel cell stack through input ports 43 and 45. The fuel cell stack includes any suitable structure for delivering portions of these streams to the respective anode and cathode regions of fuel cells 20. Fuel cell stack 24 also includes outlet ports 67 and 69 through which the anode and cathode exhaust streams from the cells are removed from the fuel cell stack. It is within the scope of the present disclosure that other configurations and constructions may be utilized, but having the ports associated with the end plates may be desirable in many applications because of the increased thickness and stability of the end plates.

Although not required to all embodiments, the fuel cell stack may also include at least one inlet and outlet port 61 and 63 through which heat exchange fluid 65 is delivered and removed from the fuel cell stack to maintain the fuel cell stack at a predetermined operating temperature, or range of temperatures. The heat exchange fluid may be delivered via any suitable mechanism and may form either an open or closed heat exchange assembly. Illustrative, non-exclusive examples of suitable heat exchange fluids include air, water, and glycols, although others may be used. It is within the scope of the present disclosure to use other mechanisms to heat and/or cool fuel cell stack 24, such as those shown in U.S. Pat. Nos. 4,583,583 and 5,879,826, the complete disclosures of which are herein incorporated by reference for all purposes. In the schematic examples shown in FIG. 6, the inlet and outlet ports are respectively illustrated on end plates 12 and 14. While this construction is not required, the relative thickness and stability of the end plates makes them suitable for the inclusion of these ports. It is within the scope of the present disclosure that the ports may be formed in any suitable location on the stack. For example, the ports may all extend through the same end plate, at least one inlet port and at least one outlet port may extend through the same end plate, at least one of the ports may extend through a portion of the fuel cell stack other than the end plates, etc.

The fuel cells in partitioned fuel cell stack 24 are supported and compressed together between the end plates by a stack compression assembly 100. Assembly 100 is adapted to draw the end plates toward each other and thereby apply compression to the fuel cells in a direction transverse to the faces, or planes, of the generally planar fuel cells. This is schematically illustrated with arrows in FIGS. 5 and 6. This compression urges the fuel cells together to maintain effective seals and electrical contacts between the components of the stack, as well as the components of the individual cells. The amount of compression to be applied may vary according to such factors as the construction of the fuel cells, including the type of gaskets used to form seals, the construction of the gas diffusion layers used in the cells, the desired operating conditions of the fuel cell stack, etc. As indicated above, all of the fuel cells in partitioned stack 24 are compressed together by the compression assembly even though the fuel cells may be separated into two or more subassemblies within the stack.

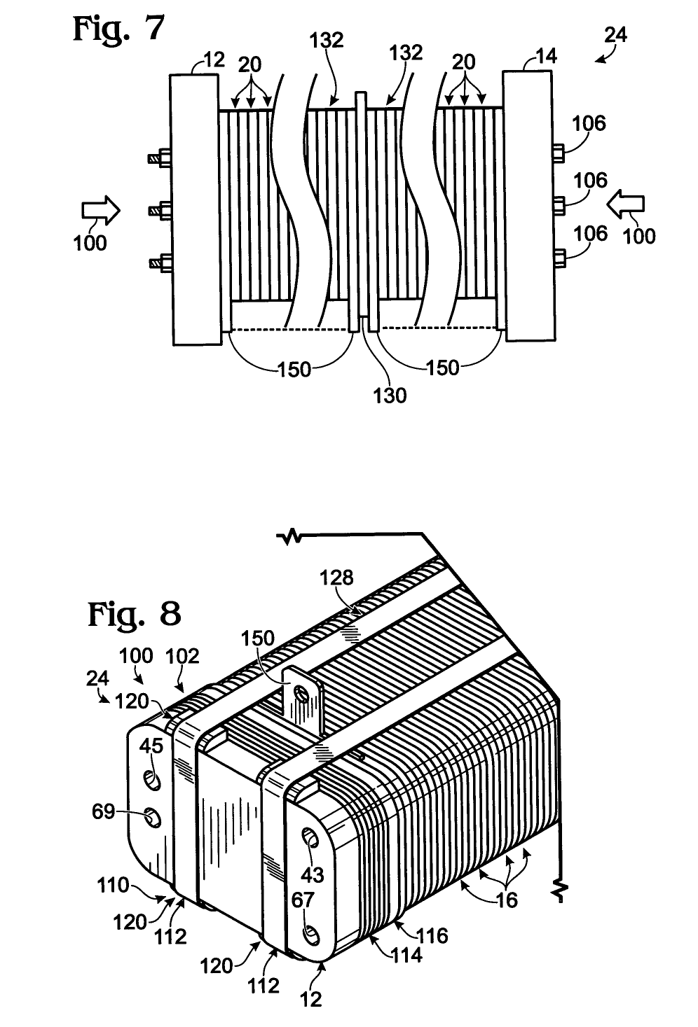

Any suitable number and type of mechanisms may be utilized to provide the desired compression to the fuel cells in stack 24. In the illustrative example shown in FIG. 7, compression assembly 100 includes a plurality of bolts 106 that extend through the end plates, and optionally through corresponding bores in the fuel cells that are supported between the end plates. Additionally or alternatively, the bolts may extend between the end plates without extending through the individual fuel cells that are supported between the end plates. Instead, the bolts may extend exterior to the outer perimeter of the fuel cells. It is within the scope of the present disclosure that any suitable type and/or number of compression assemblies may be utilized. Additional examples of suitable compression assemblies that may, but are not required to be, used with fuel cell stacks according to the present disclosure are disclosed in U.S. Provisional Patent Application Ser. Nos. 60/623,156 and 60/630,710, the complete disclosures of which are hereby incorporated by reference herein for all purposes.

In FIG. 8, an illustrative example of a suitable compression assembly 100 that is disclosed in the above-incorporated patent applications and which may be used with partitioned fuel cell stacks according to the present disclosure is shown. As shown, compression assembly 100 includes a strap assembly 110 that extends around the end plates of the fuel cell stack to compress the end plates toward each other and thereby provide the previously described compression to the fuel cells in the stack. Band 112 may be described as forming a closed loop that extends around the end plates and fuel cells of the stack. As such, compression assembly 100 may be referred to as a banded compression assembly 102. In the illustrated example shown in FIG. 8, a pair of spaced-apart bands 112 are shown extending generally parallel to each other. It is within the scope of the present disclosure that strap assembly 110 may utilize a single band or more than two bands. When two or more bands are used, it is also within the scope of the present disclosure that the bands may extend in orientations other than parallel, side-by-side orientations relative to each other. For example, the bands may extend at intersecting or divergent angles relative to each other, may extend at right angles to each other, etc. The number of bands to be used may be affected by the desired degree of compression to be applied by each band, the desired degree of compression to be applied by the compression system collectively, the material(s) from which the band is formed, and the size (i.e., thickness, width, etc.) of the band. For example, if it is desirable to apply at least 600 pounds of force to the end plates, then strap assembly 110 may include a pair of bands that each apply at least 300 pounds of force, three bands that each apply at least 200 pounds of force, a single band that applies at least 600 pounds of force, etc. While not required, it may be desirable to use more than one strap to increase the distribution of the applied compressive force across the end plates, such as to resist deformation of the end plates that could lead to leaks or reduced electrical contact.

Bands 112 may be formed from any suitable material that may apply the desired compression to the stack. Illustrative materials include metal, such as stainless or other steel, and plastic or polymeric materials. The bands may have a defined perimeter or may be at least slightly elastically deformable. Also shown in FIG. 8 are optional projecting members 120 that may be selectively utilized to space the bands further away from the perimeters of the fuel cells within the partitioned fuel cell stack.

The partitioned fuel cell stack may, but is not required to, also include or be in fluid communication with a humidification region, or assembly, in which the air or other oxidant stream for the cathode regions is humidified, such as through exposure to a water-containing stream. An illustrative example of such a stream is cathode exhaust stream 55, although others may be used. This exchange may be accomplished by passing the streams, within or exterior of the fuel cell stack, through a humidification assembly that includes a humidification membrane through which water may pass from the cathode exhaust (or other water-containing) stream to the air or other oxidant stream. FIG. 8 illustrates an example of a humidification region 114 that is incorporated within the fuel cell stack. In FIG. 8, the humidification region extends between one of the stack's end plates and the plurality of fuel cells 20. Also shown is a transition region 116 that separates the humidification region and the fuel cells and provides a region for distributing the corresponding fluid flows for delivery to the fuel cells in the stack. It is also within the scope of the present disclosure that the humidification occurs outside of the stack, such as with an external humidification assembly.

Partitioned fuel cell stacks according to the present disclosure further include at least one insulating, or non-conductive, partition that separates adjacent fuel cells with the fuel cell stack, thereby dividing the fuel cells within the stack into two or more subassemblies of fluidly and electrically interconnected fuel cells. Therefore, unlike conventional PEM and similar fuel cell stacks in which all of the fuel cells are not only in fluid communication with each other, but also which are at all times in electrical communication with each other, fuel cell stacks according to the present disclosure include at least one non-conductive partition, or barrier, that separates the fuel cells within the stack into distinct groups of electrically (and optionally fluidly) interconnected fuel cells. In FIGS. 5-7, partitions are generally indicated at 130 and divide the fuel cells 20 in the stack into two subassemblies 132. Each subassembly includes a plurality of fuel cells 20 that are in fluid communication with each other and which are electrically interconnected. As discussed, the fuel cells 20 from both subassemblies are supported between the end plates of the fuel cell stack, and in some embodiments all of the cells of the stack are in fluid communication with each other. However, partition 130 provides a non-conductive barrier that interrupts the conductive path that otherwise would exist between all of the cells in the stack. By “fluid communication” it is meant that fluids, such as fuel, oxidant, and exhaust gases may flow from cell-to-cell within the subassembly, such as through defined fluid conduits. By “electrically interconnected” and “electrical communication,” it is meant that the cells in the subassembly collectively define a conductive path through which the flow of liberated electrons (i.e., the electric current) may travel.

Partition 130 may have any suitable shape and geometry that enables the partition to provide the non-conductive barrier between the subassemblies of fuel cells defined by the partition. As discussed in more detail herein, although it is within the scope of the present disclosure that fluids may flow through the partition, such as to enable all of the fuel cells in the stack to be in fluid communication with each other, this is not a requirement. For example, in some embodiments, partition 130 may be constructed to provide both a fluid and a conductive barrier between adjacent subassemblies of fuel cells. Partition 130 should be constructed to be stable under the operating conditions experienced during use of the corresponding fuel cell stack 24. For example, at least in the context of many PEM fuel cell stacks, it may be desirable (although not required for all embodiments) for the partition to be formed from a non-porous electrical insulator that is chemically and physically stable at temperatures up to approximately 100° C., such as temperatures up to 50-90° C. In some embodiments, it may be desirable for at least the exterior surface of the partition to be chemically and physically stable in acidic environments, as it is possible for acidic conditions to exist within the fuel cell stack. Illustrative, non-exclusive examples of suitable materials for at least some PEM fuel cell stacks include polypropylene, polyethylene and nylon. While it may be desirable for the entire partition to be formed from a non-conductive material, it is within the scope of the present disclosure that portions of the partition may be formed from conductive materials so long as these materials do not define a conductive path between the subassemblies that are separated by the partition. For example, a conductive core may be used if it is coated or otherwise suitably covered with a non-conductive material.

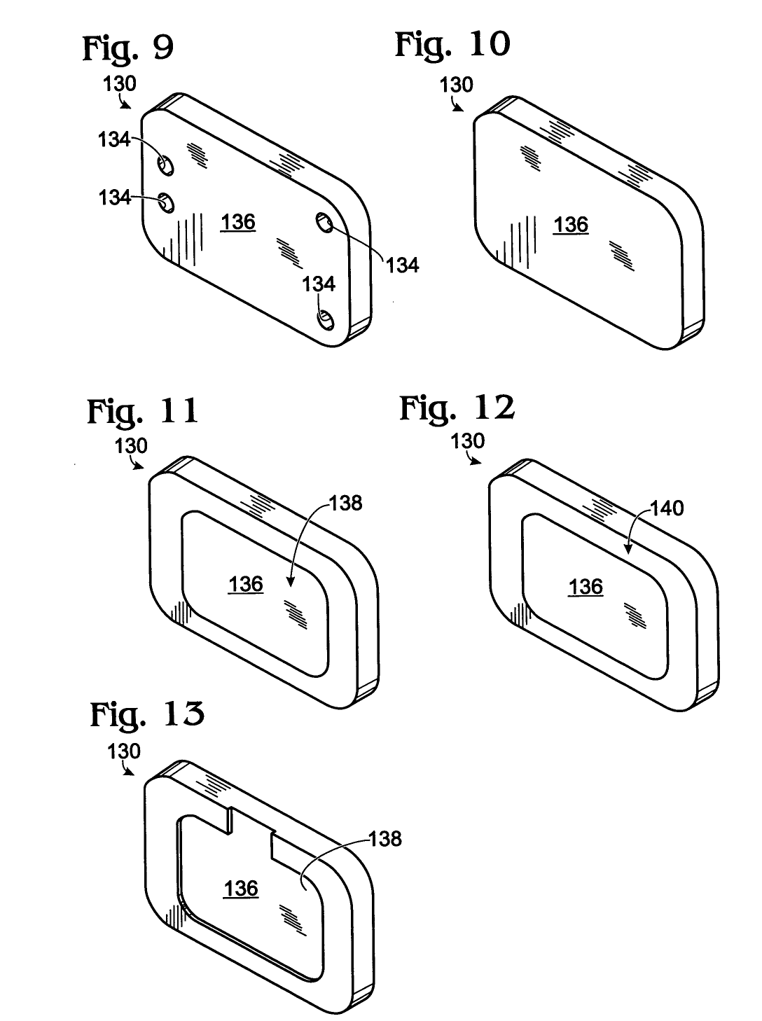

Illustrative, non-exclusive examples of partitions 130 according to the present disclosure are shown in FIGS. 9-13. Partition 130 will typically correspond at least to the perimeter shape of the fuel cells of the fuel cell stack. For example, the partition may have the same perimeter shape and size as the fuel cells, but this is not required. For example, in some embodiments, it may be desirable for the partition to have a larger perimeter than the corresponding fuel cells on opposing sides of the partition, with the partition thereby extending outwardly beyond at least a portion, or all, of the outer perimeter of the corresponding fuel cells.

As discussed, partition 130 may be configured so that it does not restrict fluid flow between the fuel cells on opposite sides of the stack. In such a configuration, all of the fuel cells in the stack may receive flows of fuel and/or oxidant from common delivery ports and/or all cathode and/or anode exhaust streams from all of the fuel cells in the stack may be withdrawn from common exhaust ports. An example of a partition 130 that is configured to enable this fluid communication between fuel cells from the subassemblies on opposed sides of the partition is shown in FIG. 9. As shown, partition 130 includes fluid conduits 134. The position and/or size of fluid conduits 134 may correspond with the conduits that extend through the fuel cells within the subassemblies.

As also discussed, in some embodiments, the partition may be configured to provide a non-conductive barrier that also restricts fluid flow therethrough. An illustrative example of such a partition is shown in FIG. 10. In such an embodiment, the fuel, oxidant and other fluid streams cannot pass through the partition and therefore may need to pass through suitable external conduits to flow from one subassembly to the next. Alternatively, the fuel cell stack may be configured to receive (or create from a received stream) or separate fluid streams for delivery to each subassembly, such as through inlet and outlet ports associated with the same end plate.

In FIGS. 9 and 10, partition 130 is illustrated as having a generally planar geometry with smooth faces 136. This construction is not required to all embodiments. For example, it may be desirable in some embodiments, for one or both faces of the partition to include one or more recesses and/or projections. For example, the raised and/or recessed portions of the partition may be configured to promote sealing between the partition and adjacent structures, to define flow fields, such as would otherwise be present as part of a bipolar plate assembly, and/or to assist in the position of the partition relative to adjacent components of the fuel cell stack. In FIG. 11, reference numeral 138 schematically illustrates that the central portion of the partition's face 136 may include one or more recessed and/or projecting/raised regions, and in FIG. 12, reference numeral 140 schematically illustrates that the perimeter portion of the partition's face 136 may include one or more recessed and/or projecting/raised regions. It is also within the scope of the present disclosure that the portions of both the central and perimeter portions of the face, and even the entirety of the face, may include raised and/or recessed regions. FIG. 13 illustrates an example of a partition 130 that includes a recessed region 142 sized to receive a conductive current collector 150, which is discussed in more detail herein.

Also shown in at least FIGS. 5-7 are electrical contacts, or current collectors, 150 that are in electrical communication with the fuel cells in each subassembly 132. As shown in FIGS. 5-7, the fuel cell stacks include a contact at each end of each subassembly. Described in another way, the fuel cell stack includes a contact proximate each end plate of the stack, as well as a contact on or adjacent each opposed face of the partition. Contacts 150 have been schematically depicted in FIGS. 5-7 and may be accessible from a variety of locations. An external load is electrically connected to the subassembly via the contacts to enable power output from the subassembly to be used to satisfy the load. This connection may be implemented via any suitable structure and pathway. For example, the subassembly's current collectors may be electrically connected to a DC bus to which one or more energy-consuming devices (and/or other load-applying devices) are selectively connected to apply loads to the subassembly. Current collectors 150 may be formed from any electrically conductive material suitable for use in a particular fuel cell stack 24. An illustrative, non-exclusive example of a suitable construction for current collectors to be used in at least PEM fuel cell stacks is for the current collectors to take the form of copper plates.

In the embodiments illustrated in FIGS. 5-7, stack 24 includes a pair of subassemblies 132 that each has the same number of fuel cells. For example, and without limitation, if each subassembly is adapted to provide a power output having a nominal voltage of 12 volts, then a power output having this nominal voltage may be selectively drawn from each subassembly by coupling a particular load to the current collectors on each end of the corresponding subassembly. While this separate utility of each subassembly is within the scope of the present disclosure, in many embodiments it may be desirable to apply the same, or similar (such as +/−20%) load to both subassemblies. Especially when all of the cells in the fuel cell stack are in fluid communication with each other, it may be desirable to apply the same or similar loads to both subassemblies. Expressed in slightly different terms, partitioned fuel cell stacks 24 according to the present disclosure may be configured to apply a load to the entirety of the fuel cells in the stack, even though the stack includes at least one partition that divides the fuel cells into subassemblies.

As discussed, it is sometimes desirable to produce a power output having a different nominal voltage than would be obtained from the partitioned fuel cell stacks shown in FIGS. 5-7. By having two (or more) subassemblies 132, the nominal voltage of the power output produced by the fuel cell stack may be doubled by selectively electrically connecting the subassemblies in series. As schematically illustrated in FIG. 14, a partitioned fuel cell stack 24 according to the present disclosure may include a jumper, or electrically conductive member, 160 that electrically interconnects the current collectors on opposing sides of a partition 130. Jumper 160 may also be referred to as providing an electrical bridge or an electrically conductive path between the current collectors that are separated by a partition.

Jumper 160 may be permanently connected between the corresponding current collectors, and may even be hardwired between the corresponding current collectors. However, it is also within the scope of the present disclosure that jumper 160, when present, is designed to be removably connected between the current collectors. A potential benefit of simply having the option to include or remove jumper 160 is that the fuel cell stack may be configured to produce a power output having selected one of two different nominal voltages when a load is applied to all of the cells in the stack. For example, if each subassembly is adapted to produce a power output having a nominal voltage of X volts, then the addition of jumper 160 to connect the subassemblies in series will result in the fuel cell stack being adapted to produce a power output having a nominal voltage of 2× volts. Described in a different way, the partitioned fuel cell stack may be adapted to produce a power output having a first nominal voltage when the power output is produced from all of the fuel cells with the subassemblies connected in parallel. However, by adding jumper 160 to connect the subassemblies in series, the nominal voltage of the power output is reduced to half (or approximately half) of the nominal voltage of the former power output.

As a more particular example, partitioned fuel cell stacks may be configured to produce a power output having a nominal voltage of 6 volts, 12 volts, 18 volts, 24 volts, etc. when the jumper is not present, but a power output having a nominal voltage of 12 volts, 24 volts, 36 volts, 48 volts, etc. when the jumper is present. As a non-exclusive application of this selectivity, a manufacturer may produce essentially the same fuel cell stack and selectively add or remove jumper 160 depending upon the intended nominal voltage of the power output to be produced when the stack is operated with the load being applied to all of the cells in the stack. Similarly, a technician or other sufficiently knowledgeable individual may selectively add or remove the jumper after manufacture of the partitioned fuel cell stack. From the above examples, it should be evident that the frequent use of “partitioned fuel cell stack” to describe fuel cell stacks according to the present disclosure does not require at all times that the subassemblies be electrically isolated from each other. Instead, it refers to the presence of one or more non-conductive partitions that divide the plurality of fuel cells into two or more subassemblies, which as discussed, may or may not be electrically isolated from each other, such as depending upon whether or not a jumper is present and/or whether or not a subsequently described switch, when present, is open or closed.

In a variation of the above construction, the jumper (or other voltage-determining assembly) may include a suitable switch that selectively connects the subassemblies in series and parallel configurations to change the nominal voltage of the power output produced by the partitioned fuel cell stack. In some embodiments, the jumper may be described as including a switch that is selectively configured between at least a first configuration, in which the switch enables the jumper to establish an electrical connection between the first and the second fuel cell subassemblies, and a second configuration, in which the switch does not form a portion of an electrical connection between the first and the second fuel cell subassemblies. In some embodiments the first configuration results in a series interconnection between the fuel cell subassemblies and the second configuration results in a parallel interconnection between the fuel cell subassemblies. The switch may thereby selectively configure the fuel cell stack to provide a power output a selected one of a plurality of predetermined nominal voltages. The switch and/or jumper or other voltage-determining assembly may be configured to retain its selected configuration regardless of the load applied to the fuel cell stack.

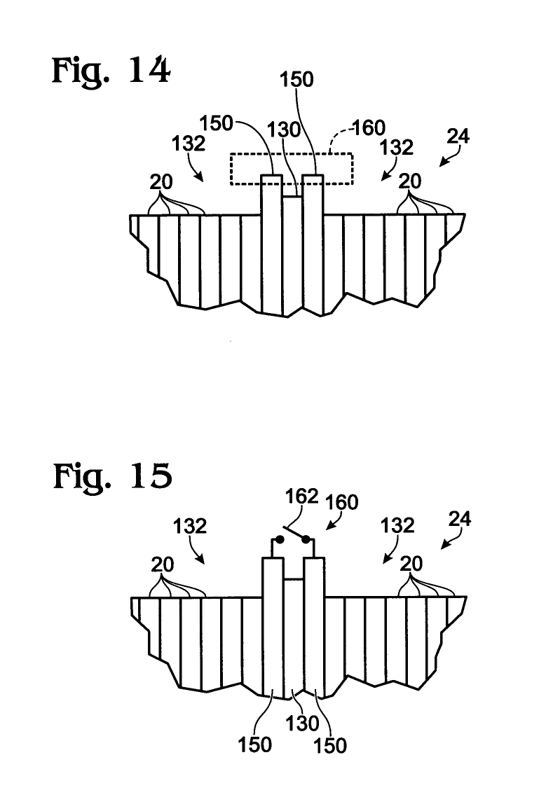

FIG. 15 provides a schematic representation of a jumper that includes a switch, which is indicated generally at 162. Any suitable switch or other suitable structure for selectively permitting and restricting current flow between the corresponding current collectors may be used. Jumper 160 and switch 162 may collectively be referred to as a bridge assembly, or voltage-determining assembly. It is within the scope of the present disclosure that switch 162, when present, may be adapted to be selectively opened and closed responsive to any suitable input or mechanism. For example, switch 162 may include or be in communication with a manually actuated portion that is actuated by a user, i.e., to receive a user input selecting a particular configuration of the switch, to selectively open or close the switch. As another example, the switch may be adapted to be opened or closed responsive to whether or not a plug is inserted by a user into a particular outlet associated with the fuel cell stack. As another example, the switch may be electronically controlled, such as responsive to an input signal from a controller that configures the fuel cell stack to provide a selected one of the predetermined available nominal voltages.

With the inclusion of partition 130, stack 24 is adapted to selectively provide power outputs having two or more nominal, or designated operating, voltages. It should be understood that the actual voltage of the power outputs may vary during use of the fuel cell system, such as responsive to such factors as the magnitude of the applied load and the performance of the fuel cell stack. For example, as the applied load increases in magnitude, the voltage of the power output being utilized to satisfy the load will decrease. However, fuel cell systems are still adapted under normal operating conditions to produce power output(s) having nominal voltages within predetermined voltage ranges. For example, the systems may have nominal voltages of 12 volts, 18 volts, 24 volts, 36 volts, 48 volts, etc., with the voltage of the power output produced by the stack often being within approximately 20% (and in many embodiments within −10% and +20%) of this normal operating voltage during proper operation of the fuel cell stack to satisfy an applied load. These illustrative ranges emulate the range of acceptable voltages for energy-consuming devices adapted to be powered by conventional lead-acid batteries. Fuel cell systems according to the present disclosure may be adapted to emulate, or provide, the range of operative voltages produced by other battery designs and/or chemistries. As discussed, it is within the scope of the present disclosure that partitioned fuel cell stacks, similar to conventional fuel cell stacks, are adapted to produce power utilizing all of the fuel cells in the stack. However, the power output produced by the stack may be selectively drawn from the entire stack or from one or more of the sub-assemblies.

The number of fuel cells 20 in any particular partitioned fuel cell stack 24 and/or subassembly 132 may vary without departing from the scope of the present disclosure. While in many embodiments it may be desirable to have the same number of fuel cells in each subassembly, this is not required. Similarly, while in many embodiments it may be desirable to apply the same load to all of the subassemblies, this too is not required to all embodiments. For example, in many applications, it may be desirable to convert the power output to 110V AC or 220V AC. However, a portion of the power output may need to be used as a DC power output, such as to power the balance of plant component of the fuel cell system. This subset of the total power output may be selectively drawn from the power output from a selected subassembly. It is within the scope of the present disclosure that the fuel cell stack includes a subassembly that is dedicated to providing a power output to satisfy the balance of plant and other operating loads of the fuel cell system. Alternatively, the load applied by (or the amount of the power output drawn to satisfy) the balance of plant components of the fuel cell system may be applied with the rest of the applied load and thereby may be evenly applied to all of the subassemblies, or it may be applied to one or a subset (less than all) of the subassemblies.

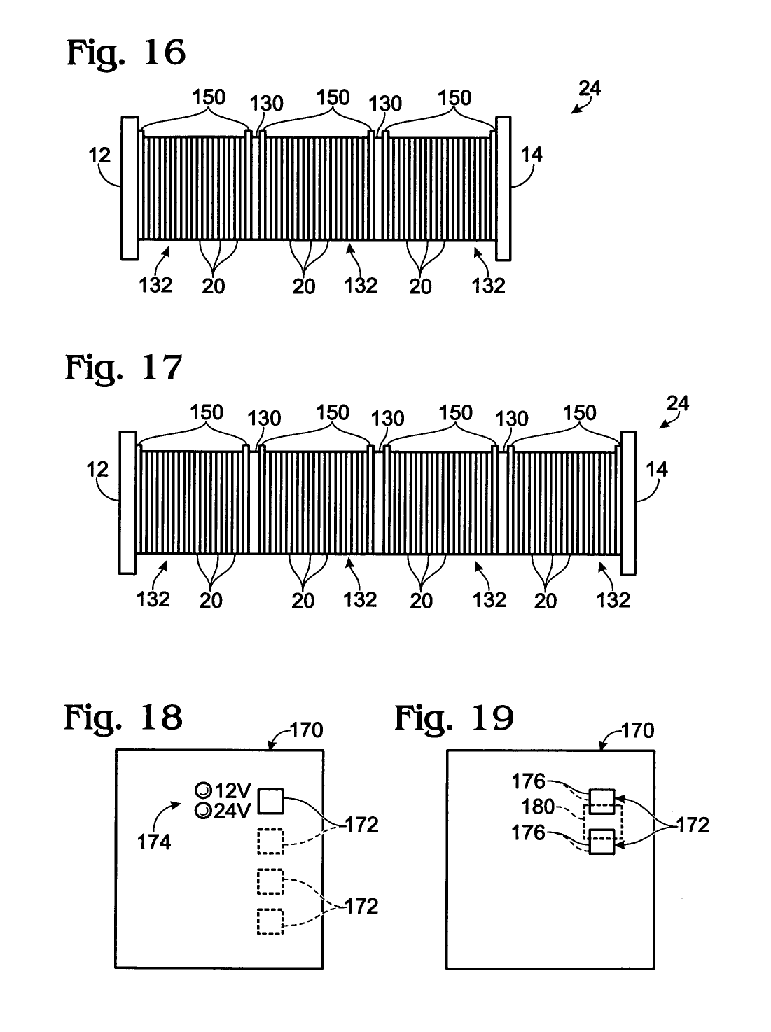

Continuing with the above discussion, the intended application for the stack and/or type and/or number of energy-consuming devices 52 to be powered by the stack may be factors that affect the number of cells in each stack and/or each subassembly. Similarly, the number of partitions (and thus the number of subassemblies) in a particular stack may also vary without departing from the scope of the present disclosure. For example, FIGS. 16 and 17 provide schematic examples of partitioned fuel cell stacks 24 that include two and three partitions, respectively, thereby dividing the fuel cells of the corresponding stacks into three and four subassemblies 132, respectively. Similar to the previously discussed and illustrated examples, each of the subassemblies includes a plurality of fuel cells, with the fuel cells from all of the subassemblies being supported between common end plates. While not required, it may be desirable for all of the subassemblies to include the same number and type of fuel cells. In the illustrated embodiments, the partitions are evenly spaced within the fuel cells to divide the fuel cells into even halves, thirds, and quarters, but this even spacing may not be present in every partitioned fuel cell stack according to the present disclosure. As such, evenly distributed and unevenly distributed spacings of the partitions amongst the fuel cells are both within the scope of the present disclosure.

It is also within the scope of the present disclosure that any suitable number of partitions, including more than the 1-3 partitions illustrated previously, may be used. For example, partitioned fuel cell stacks according to the present disclosure may include 4, 5, 6, 7, or more partitions, and thereby may include 5-8 or more subassemblies supported between the end plates of the fuel cell stack. In some embodiments, it may be desirable for the number of partitions to be an odd number (or the number of subassemblies to be an even number). A potential benefit of this construction is that it provides for a greater number of potential nominal configurations that also permit the load to be evenly (or essentially evenly) applied to all of the subassemblies.

A factor to be considered when determining how many partitions to include in a particular stack is the number of discrete nominal operating voltages that a partitioned fuel cell stack is intended to be configurable to selectively provide. As an illustrative example, if each subassembly is adapted to provide a nominal voltage of 12 volts, then a stack with three partitions (four equal subassemblies) would be configured to selectively provide nominal voltages of 12 volts, 24 volts or 48 volts, depending upon whether the subassemblies are connected in series or parallel. It should be understood that the number of subassemblies and the nominal voltages to be provided thereby are scalable. For example, if each subassembly was adapted to provide a nominal voltage of 6 volts, then the illustrative example discussed immediately above would be configurable to provide nominal voltages of 6 volts, 12 volts, or 24 volts.

Another factor that may be considered is the nominal voltage provided by the fuel cells (or the membrane electrode assemblies therein) being used in the stack. As discussed, it is within the scope of the present disclosure that a partitioned fuel cell stack is designed to provide, or emulate, the range of voltages that conventionally are received from properly operating lead-acid or other batteries. Thus, the stack may be used to provide power to a device that has been rated for a particular nominal voltage (and thus the expected range of actual voltages that are conventionally experienced when the device is powered by a particular type of battery).

Partitioned fuel cell stacks according to the present disclosure may be constructed to have any suitable rated power output. For example, partitioned fuel cell stacks 24 according to the present disclosure may be designed to have a rated power output in the range of 100-400 watts, such as for use as battery chargers, generators for backup power, wheelchairs, scooters, portable power systems, power systems for electrically powered components of recreational vehicles and seacraft, power sources for tools, appliances, and some computers and communication equipment. As another example, stacks 10 may have a rated power output of approximately 1-1.5 kW for use supplying power to larger appliances, series of electronic devices, etc. As yet another example, a rated power output in the range of 3-6 kW, such as 4-5 kW may be suitable for supplying power to a household, apartment, office and the like. Despite the potential for selectively providing a power output having a nominal voltage selected from a number of predetermined nominal voltages that the fuel cell stack is selectively adapted to provide, partitioned fuel cell stacks according to the present disclosure may still include, or be in communication with, at least one power management module 77 that includes any suitable structure to convert the electric current produced by the fuel cell stack to the appropriate power configuration for device 52, such as by adjusting the voltage of the stream (i.e., with a buck or boost converter), the type of current (alternating or direct), etc.

As discussed above, partitioned fuel cell stacks 24 according to the present disclosure are configured to provide a power output having one of a discrete number of predetermined nominal voltages. This nominal voltage is determined by whether the subassemblies of the partitioned fuel cell stack are electrically connected in parallel or series, with the power output preferably being produced by all of the fuel cells in the stack. Therefore, the electrical configuration of the subassemblies, and thus the selected nominal power output is typically selected from the available discrete number of choices prior to operation of the fuel cell stack to produce the power output.

In FIGS. 18 and 19, housings for fuel cell stacks and/or fuel cell systems according to the present disclosure are somewhat schematically illustrated at 170. As shown, the housing includes at least one outlet, or socket, 172 that is adapted to receive a corresponding outlet, or plug, to electrically connect an energy-consuming device to the fuel cell stack. Because partitioned fuel cell stacks according to the present disclosure may selectively provide a power output having one of a predetermined number of nominal voltages, in some embodiments it may be desirable to have an indicator that notifies a user of the selected nominal voltage, such as a visual indication of the nominal voltage of the power output that the fuel cell stack is configured to provide. FIG. 18 provides at 174 a graphical example of a housing that provides such an indicator. An illustrative example of a suitable indicator is one or more lights that selectively indicate which of the available nominal voltages is to be provided. As another example, the indicator may take the form of a display that provides this indication. The information to be displayed by the indicator may be preselected by a technician or other user. Alternatively, the fuel cell system may be adapted to detect the nominal voltage of the stack and to provide an indication of this voltage to the user.

FIG. 19 illustrates an example of a housing 170 that includes two or more sockets or other suitable electrical outlets 172, with at least first one 176 of the outlets being adapted to be used to electrically interconnect the fuel cell system with an energy-consuming device that is designed to receive a power output having a first (predetermined) nominal voltage, and at least a second one 178 of the outlets being adapted to be used to electrically interconnect the fuel cell system with an energy-consuming assembly that is designed to receive a power output having a second (predetermined) nominal voltage that is different than the first nominal voltage. In such an embodiment, the nominal voltage of the power output may be selected by a switch or other sensor associated with one or more of the outlets, with the nominal voltage of the power output being determined responsive to which outlet receives a corresponding plug from an energy-consuming device. In the illustrative examples shown in FIGS. 18 and 19, the indicated nominal voltages are 12 volts and 24 volts, but this number of nominal voltages, and the magnitude of the nominal voltages themselves, may vary without departing from scope of the present disclosure. For example, the housing may be configured to receive plugs for devices rated for more than two different nominal volts (such as 6, 12, and 24 volts; 12, 24, and 48 volts, etc.

It is within the scope of the present disclosure that the housing may include a plurality of outlets 176 that are adapted to electrically interconnect the fuel cell system with energy-consuming devices that are designed to receive a power output having a first (predetermined) nominal voltage, and a plurality of outlets 178 that are adapted to electrically interconnect the fuel cell system with energy-consuming devices that are designed to receive a power output having a second (predetermined) nominal voltage that is different than the first (predetermined) nominal voltage. In such an embodiment, the fuel cell system may be described as including a first outlet assembly that includes at least one socket or other outlet that is adapted to electrically interconnect the fuel cell system with an energy-consuming device that is designed to receive a power output having a first (predetermined) nominal voltage, and a second outlet assembly that includes at least one socket or other output that is adapted that to electrically interconnect the fuel cell system with an energy-consuming device that is designed to receive a power output having a second (predetermined) nominal voltage that is different than the first nominal voltage.

Additionally or alternatively, the housing and/or sockets may include a gate, baffle, key structure or similar restriction device that restricts the insertion of a plug for a device that is adapted to receive a power output having a different nominal voltage than a device whose plug has already been inserted into a corresponding socket. For example, two or more sockets may be located in proximity with each other, with a rotatable or slidable gate that permits insertion into one or more sockets designed to provide a power output having the same nominal voltage while restricting insertion of plugs into one or more other sockets that are designed to provide a power output having a different nominal voltage. This optional gate structure is indicated schematically in dashed lines in FIG. 19 at 180.

The references to “plugs” and “sockets” in the preceding discussion of illustrative configurations is not intended to require that the housing only includes sockets and that the energy-consuming devices only include plugs. It is within the scope of the present disclosure that the fuel cell system and energy-consuming devices may include any suitable electrical couplings that are complimentarily configured to be selectively connected together to provide an electrical path for the fuel cell system to provide power to the energy-consuming device.

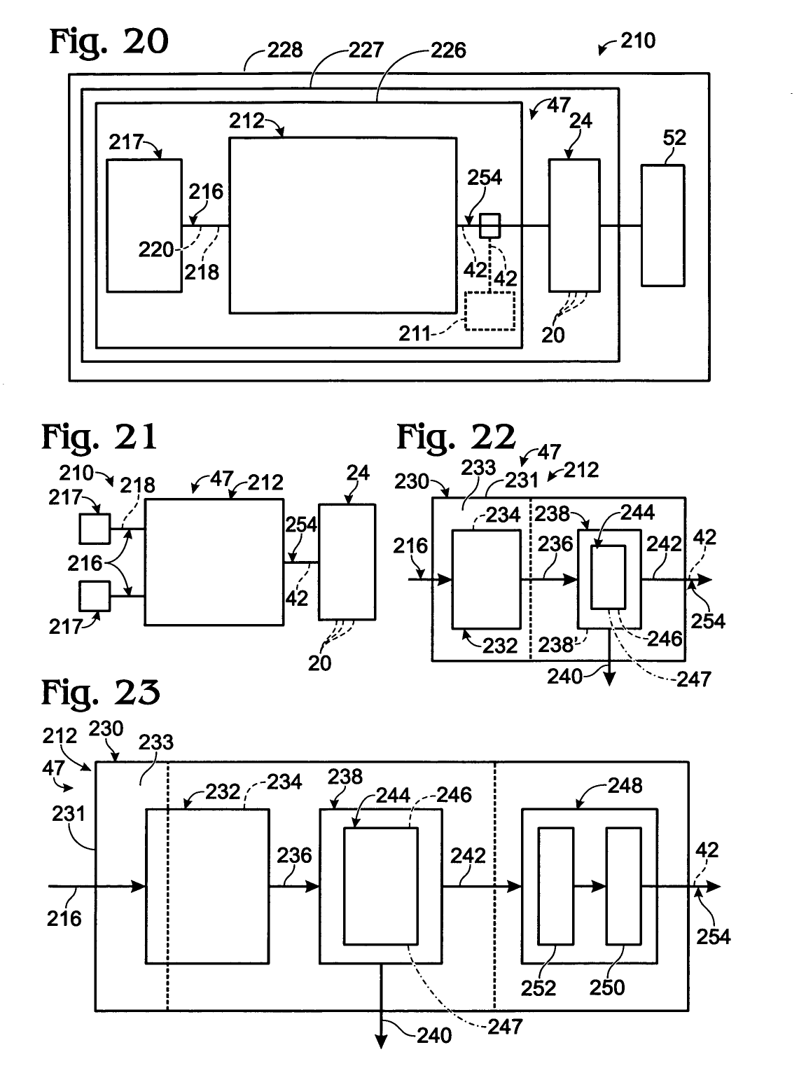

As discussed above, partitioned fuel cell stack 24 according to the present disclosure may be coupled with a source 47 of hydrogen gas 42 (and related delivery systems and balance of plant components) to form a fuel cell system. A schematic example of such a fuel cell system according to the present disclosure is shown in FIG. 18 and generally indicated at 210. As discussed previously with respect to FIG. 1, examples of sources 47 of hydrogen gas 42 include a storage device 211 that contains a stored supply of hydrogen gas, as indicated in dashed lines in FIG. 20. Examples of suitable storage devices 211 include pressurized tanks and hydride beds.

An additional or alternative source 47 of hydrogen gas 42 is the product stream from a fuel processor, which produces hydrogen by reacting a feed stream to produce reaction products from which the stream containing hydrogen gas 42 is formed. As shown in solid lines in FIG. 20, system 210 includes at least one fuel processor 212 and at least one partitioned fuel cell stack 24. Fuel processor 212 (and its associated feedstock delivery system, heating/cooling assembly, and the like) may be referred to as a hydrogen-generation assembly that includes at least one hydrogen-generating region. Fuel processor 212 is adapted to produce a product hydrogen stream 254 containing hydrogen gas 42 from a feed stream 216 containing at least one feedstock. One or more partitioned fuel cell stacks 24 are adapted to produce an electric current from the portion of product hydrogen stream 254 delivered thereto. In the illustrated embodiment, a single fuel processor 212 and a single partitioned fuel cell stack 24 are shown; however, it is within the scope of the disclosure that more than one of either or both of these components may be used. It should be understood that these components have been schematically illustrated and that the fuel cell system may include additional components that are not specifically illustrated in the Figures, such as air delivery systems, heat exchangers, heating assemblies, fluid conduits, and the like. As also shown, hydrogen gas may be delivered to stack 24 from one or more of fuel processor 212 and storage device 211, and hydrogen from the fuel processor may be delivered to one or more of the storage device and stack 24. Some or all of stream 254 may additionally, or alternatively, be delivered, via a suitable conduit, for use in another hydrogen-consuming process, burned for fuel or heat, or stored for later use.

Fuel processor 212 is any suitable device that produces hydrogen gas from the feed stream. Examples of suitable mechanisms for producing hydrogen gas from feed stream 216 include steam reforming and autothermal reforming, in which reforming catalysts are used to produce hydrogen gas from a feed stream containing a carbon-containing feedstock and water. Other suitable mechanisms for producing hydrogen gas include pyrolysis and catalytic partial oxidation of a carbon-containing feedstock, in which case the feed stream does not contain water. Still another suitable mechanism for producing hydrogen gas is electrolysis, in which case the feedstock is water. Examples of suitable carbon-containing feedstocks include at least one hydrocarbon or alcohol. Examples of suitable hydrocarbons include methane, propane, natural gas, diesel, kerosene, gasoline and the like. Examples of suitable alcohols include methanol, ethanol, and polyols, such as ethylene glycol and propylene glycol.

Feed stream 216 may be delivered to fuel processor 212 via any suitable mechanism. Although only a single feed stream 216 is shown in FIG. 20, more than one stream 216 may be used and these streams may contain the same or different feedstocks. When carbon-containing feedstock 218 is miscible with water, the feedstock is typically, but not required to be, delivered with the water component of feed stream 216, such as shown in FIG. 20. When the carbon-containing feedstock is immiscible or only slightly miscible with water, these feedstocks are typically delivered to fuel processor 212 in separate streams, such as shown in FIG. 21. In FIGS. 20 and 21, feed stream 216 is shown being delivered to fuel processor 212 by a feedstock delivery system 217.

In many applications, it is desirable for the fuel processor to produce at least substantially pure hydrogen gas. Accordingly, the fuel processor may include one or more hydrogen producing regions that utilize a process that inherently produces sufficiently pure hydrogen gas, or the fuel processor may include suitable purification and/or separation devices that remove impurities from the hydrogen gas produced in the fuel processor. As another example, the fuel processing system or fuel cell system may include purification and/or separation devices downstream from the fuel processor. In the context of a fuel cell system, the fuel processor preferably is adapted to produce substantially pure hydrogen gas, and even more preferably, the fuel processor is adapted to produce pure hydrogen gas. For the purposes of the present disclosure, substantially pure hydrogen gas is greater than 90% pure, preferably greater than 95% pure, more preferably greater than 99% pure, and even more preferably greater than 99.5% pure. Suitable fuel processors are disclosed in U.S. Pat. Nos. 6,221,117, 5,997,594, 5,861,137, and pending U.S. Patent Application Publication Nos. 2001/0045061, 2003/0192251, and 2003/0223926. The complete disclosures of the above-identified patents and patent applications are hereby incorporated by reference for all purposes.

For purposes of illustration, the following discussion will describe fuel processor 212 as a steam reformer adapted to receive a feed stream 216 containing a carbon-containing feedstock 218 and water 220. However, it is within the scope of the disclosure that fuel processor 212 may take other forms, as discussed above. An example of a suitable steam reformer is shown in FIG. 22 and indicated generally at 230. Reformer 230 includes a reforming, or hydrogen-producing, region 232 that includes a steam reforming catalyst 234. Alternatively, reformer 230 may be an autothermal reformer that includes an autothermal reforming catalyst. In reforming region 232, a reformate stream 236 is produced from the water and carbon-containing feedstock in feed stream 216. The reformate stream typically contains hydrogen gas and other gases. In the context of a fuel processor generally, a mixed gas stream that contains hydrogen gas as its majority component is produced from the feed stream. The mixed gas stream typically includes other gases as well. Illustrative, non-exclusive examples of these other gases, or impurities, include one or more of such illustrative impurities as carbon monoxide, carbon dioxide, water, methane, and unreacted feedstock. The mixed gas, or reformate, stream is delivered to a separation region, or purification region, 238, where the hydrogen gas is purified. In separation region 238, the hydrogen-containing stream is separated into one or more byproduct streams, which are collectively illustrated at 240 and which typically include at least a substantial portion of the other gases, and a hydrogen-rich stream 242, which contains at least substantially pure hydrogen gas. The separation region may utilize any separation process, including a pressure-driven separation process. In FIG. 22, hydrogen-rich stream 242 is shown forming product hydrogen stream 254.

An example of a suitable structure for use in separation region 238 is a membrane module 244, which contains one or more hydrogen permeable membranes 246. Examples of suitable membrane modules formed from a plurality of hydrogen-selective metal membranes are disclosed in U.S. Pat. No. 6,319,306, the complete disclosure of which is hereby incorporated by reference for all purposes. In the '306 patent, a plurality of generally planar membranes are assembled together into a membrane module having flow channels through which an impure gas stream is delivered to the membranes, a purified gas stream is harvested from the membranes and a byproduct stream is removed from the membranes. Gaskets, such as flexible graphite gaskets, are used to achieve seals around the feed and permeate flow channels. Also disclosed in the above-identified application are tubular hydrogen-selective membranes, which also may be used. Other suitable membranes and membrane modules are disclosed in the above-incorporated patents and applications, as well as U.S. patent application Ser. Nos. 10/067,275 and 10/027,509, the complete disclosures of which are hereby incorporated by reference in their entirety for all purposes. Membrane(s) 246 may also be integrated directly into the hydrogen-producing region or other portion of fuel processor 212.

The thin, planar, hydrogen-permeable membranes are preferably composed of palladium alloys, most especially palladium with 35 wt % to 45 wt % copper, such as approximately 40 wt % copper. These membranes, which also may be referred to as hydrogen-selective membranes, are typically formed from a thin foil that is approximately 0.001 inches thick. It is within the scope of the present disclosure, however, that the membranes may be formed from hydrogen-selective metals and metal alloys other than those discussed above, hydrogen-permeable and selective ceramics, or carbon compositions. The membranes may have thicknesses that are larger or smaller than discussed above. For example, the membrane may be made thinner, with commensurate increase in hydrogen flux. The hydrogen-permeable membranes may be arranged in any suitable configuration, such as arranged in pairs around a common permeate channel as is disclosed in the incorporated patent applications. The hydrogen permeable membrane or membranes may take other configurations as well, such as tubular configurations, which are disclosed in the incorporated patents.

Another example of a suitable pressure-separation process for use in separation region 238 is pressure swing adsorption (PSA), with a pressure swing adsorption assembly being indicated in dash-lot lines at 247 in FIGS. 22 and 23. In a pressure swing adsorption (PSA) process, gaseous impurities are removed from a stream containing hydrogen gas. PSA is based on the principle that certain gases, under the proper conditions of temperature and pressure, will be adsorbed onto an adsorbent material more strongly than other gases. Typically, it is the impurities that are adsorbed and thus removed from reformate stream 236. The success of using PSA for hydrogen purification is due to the relatively strong adsorption of common impurity gases (such as CO, CO₂, hydrocarbons including CH₄, and N₂) on the adsorbent material. Hydrogen adsorbs only very weakly and so hydrogen passes through the adsorbent bed while the impurities are retained on the adsorbent material. Impurity gases such as NH₃, H₂S, and H₂O adsorb very strongly on the adsorbent material and are therefore removed from stream 236 along with other impurities. If the adsorbent material is going to be regenerated and these impurities are present in stream 236, separation region 238 preferably includes a suitable device that is adapted to remove these impurities prior to delivery of stream 236 to the adsorbent material because it is more difficult to desorb these impurities.

Adsorption of impurity gases occurs at elevated pressure. When the pressure is reduced, the impurities are desorbed from the adsorbent material, thus regenerating the adsorbent material. Typically, PSA is a cyclic process and requires at least two beds for continuous (as opposed to batch) operation. Examples of suitable adsorbent materials that may be used in adsorbent beds are activated carbon and zeolites, especially 5 Å (5 angstrom) zeolites. The adsorbent material is commonly in the form of pellets and it is placed in a cylindrical pressure vessel utilizing a conventional packed-bed configuration. It should be understood, however, that other suitable adsorbent material compositions, forms and configurations may be used.

As discussed, it is also within the scope of the disclosure that at least some of the purification of the hydrogen gas is performed intermediate the fuel processor and the fuel cell stack. Such a construction is schematically illustrated in dashed lines in FIG. 22, in which the separation region 238′ is depicted downstream from the shell 231 of the fuel processor.

Reformer 230 may, but does not necessarily, additionally or alternatively, include a polishing region 248, such as shown in FIG. 23. As shown, polishing region 248 receives hydrogen-rich stream 242 from separation region 238 and further purifies the stream by reducing the concentration of, or removing, selected compositions therein. For example, when stream 242 is intended for use in a fuel cell stack, such as stack 24, compositions that may damage the fuel cell stack, such as carbon monoxide and carbon dioxide, may be removed from the hydrogen-rich stream. The concentration of carbon monoxide should be less than 10 ppm (parts per million). Preferably, the system limits the concentration of carbon monoxide to less than 5 ppm, and even more preferably, to less than 1 ppm. The concentration of carbon dioxide may be greater than that of carbon monoxide. For example, concentrations of less than 25% carbon dioxide may be acceptable. Preferably, the concentration is less than 10%, and even more preferably, less than 1%. Especially preferred concentrations are less than 50 ppm. It should be understood that the acceptable maximum concentrations presented herein are illustrative examples, and that concentrations other than those presented herein may be used and are within the scope of the present disclosure. For example, particular users or manufacturers may require minimum or maximum concentration levels or ranges that are different than those identified herein. Similarly, when fuel processor 212 is not used with a fuel cell stack, or when it is used with a fuel cell stack that is more tolerant of these impurities, then the product hydrogen stream may contain larger amounts of these gases.

Region 248 includes any suitable structure for removing or reducing the concentration of the selected compositions in stream 242. For example, when the product stream is intended for use in a PEM fuel cell stack or other device that will be damaged if the stream contains more than determined concentrations of carbon monoxide or carbon dioxide, it may be desirable to include at least one methanation catalyst bed 250. Bed 250 converts carbon monoxide and carbon dioxide into methane and water, both of which will not damage a PEM fuel cell stack. Polishing region 248 may also include another hydrogen-producing device 252, such as another reforming catalyst bed, to convert any unreacted feedstock into hydrogen gas. In such an embodiment, it is preferable that the second reforming catalyst bed is upstream from the methanation catalyst bed so as not to reintroduce carbon dioxide or carbon monoxide downstream of the methanation catalyst bed.

Steam reformers typically operate at temperatures in the range of 200° C. and 800° C., and at pressures in the range of 50 psi and 1000 psi, although temperatures and pressures outside of these ranges are within the scope of the disclosure, such as depending upon the particular type and configuration of fuel processor being used. Any suitable heating mechanism or device may be used to provide this heat, such as a heater, burner, combustion catalyst, or the like. The heating assembly may be external the fuel processor or may form a combustion chamber that forms part of the fuel processor. The fuel for the heating assembly may be provided by the fuel processing system, by the fuel cell system, by an external source, or any combination thereof.

In FIGS. 22 and 23, reformer 230 is shown including a shell 231 in which the above-described components are contained. Shell 231, which also may be referred to as a housing, enables the fuel processor, such as reformer 230, to be moved as a unit. It also protects the components of the fuel processor from damage by providing a protective enclosure and reduces the heating demand of the fuel processor because the components of the fuel processor may be heated as a unit. Shell 231 may, but does not necessarily, include insulating material 233, such as a solid insulating material, blanket insulating material, or an air-filled cavity. It is within the scope of the disclosure, however, that the reformer may be formed without a housing or shell. When reformer 230 includes insulating material 233, the insulating material may be internal the shell, external the shell, or both. When the insulating material is external a shell containing the above-described reforming, separation and/or polishing regions, the fuel processor may further include an outer cover or jacket external the insulation.

It is further within the scope of the disclosure that one or more of the components may either extend beyond the shell or be located external at least shell 231. For example, and as schematically illustrated in FIG. 23, polishing region 248 may be external shell 231 and/or a portion of reforming region 232 may extend beyond the shell. Other examples of fuel processors demonstrating these configurations are illustrated in the incorporated references and discussed in more detail herein.

Although fuel processor 212, feedstock delivery system 217, fuel cell stack 24 and energy-consuming device 52 may all be formed from one or more discrete components, it is also within the scope of the disclosure that two or more of these devices may be integrated, combined or otherwise assembled within an external housing or body. For example, a fuel processor and feedstock delivery system may be combined to provide a hydrogen-producing device with an on-board, or integrated, feedstock delivery system, such as schematically illustrated at 226 in FIG. 20. Similarly, a fuel cell stack may be added to provide an energy-generating device with an integrated feedstock delivery system, such as schematically illustrated at 227 in FIG. 20.

Fuel cell system 210 may (but is not required to) additionally be combined with one or more energy-consuming devices 52 to provide the device with an integrated, or on-board, energy source. For example, the body of such a device is schematically illustrated in FIG. 20 at 228.

### INDUSTRIAL APPLICABILITY

The fuel cell stacks and fuel cell systems disclosed herein are applicable to the energy-production industries, and more particularly to the fuel cell industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Where the disclosure or subsequently filed claims recite “a” or “a first” element or the equivalent thereof, it should be within the scope of the present inventions that such disclosure or claims may be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A fuel cell system, comprising:
at least one fuel cell stack, comprising:
a pair of end plates;
a plurality of fuel cells supported between the pair of end plates, wherein each of the fuel cells is adapted to receive fuel and an oxidant and to produce an electric current therefrom, and further wherein the fuel cell stack is adapted to satisfy an applied load utilizing a power output drawn from all of the fuel cells in the fuel cell stack, and further wherein the fuel cell stack is adapted to selectively provide the power output at a selected predetermined nominal voltage;
a partition dividing the plurality of fuel cells into first and second fuel cell subassemblies that each include a plurality of electrically interconnected fuel cells; wherein the partition includes first and second opposed sides and is adapted to provide a non-conductive barrier between the first and the second plurality of fuel cells;
a plurality of current collectors associated with the fuel cell subassemblies, wherein the plurality of current collectors includes at least a pair of current collectors in electrical communication with each of the fuel cell subassemblies and adapted to provide an electrical connection between the fuel cell subassembly and an applied load; and
a voltage-determining assembly adapted to selectively establish an electrical connection between the first fuel cell subassembly and the second fuel cell subassembly; wherein the fuel cell stack is adapted to provide a power output having a first predetermined nominal voltage when the voltage-determining assembly provides an electrical connection between the first fuel cell subassembly and the second fuel cell subassembly, and further wherein the fuel cell stack is adapted to provide a power output having a second predetermined nominal voltage that is different than the first predetermined nominal voltage when the voltage-determining assembly does not provide an electrical connection between the first fuel cell subassembly and the second fuel cell subassembly.

2. The fuel cell system of claim 1, wherein the fuel cell stack includes a compression assembly adapted to draw the end plates toward each other to apply compression to all of the plurality of fuel cells.

3. The fuel cell system of claim 1, wherein the fuel cell stack is adapted to receive streams of fuel and oxidant, wherein the fuel cell stack includes delivery conduits adapted to deliver fuel and oxidant to each of the fuel cells in the fuel cell stack, and further wherein the partition includes fluid conduits through which the fuel and oxidant may flow between fuel cells in the first and the second fuel cell subassemblies.

4. The fuel cell system of claim 1, wherein the fuel cell stack is adapted to receive streams of fuel and oxidant, wherein the fuel cell stack includes delivery conduits adapted to deliver fuel and oxidant to each of the fuel cells in the fuel cell stack, and further wherein the partition is a fluid-impermeable partition that is further adapted to prevent fuel and oxidant from flowing through the partition between the first and the second fuel cell subassemblies.

5. The fuel cell system of claim 1, wherein the voltage-determining assembly is selectively configured between a first configuration, in which the voltage-determining assembly establishes an electrical connection between the first and the second fuel cell subassemblies, and a second configuration, in which the voltage-determining assembly does not establish an electrical connection between the first and the second fuel cell subassemblies, and further wherein the voltage-determining assembly is adapted to retain its configuration regardless of the load applied to the fuel cell stack.

6. The fuel cell system of claim 1, wherein the fuel includes hydrogen gas as at least a majority component.

7. The fuel cell system of claim 6, wherein the system includes a fuel processing assembly adapted to produce the fuel for the fuel cell stack.

8. The fuel cell system of claim 1, wherein the voltage-determining assembly is adapted to selectively establish an electrical connection between a current collector in electrical communication with the first fuel cell subassembly and a current collector in electrical communication with the second fuel cell subassembly.

9. The fuel cell system of claim 1, wherein the first predetermined nominal voltage is twice the second predetermined nominal voltage.

10. The fuel cell system of claim 9, wherein the first predetermined nominal voltage is 24 volts.

11. The fuel cell system of claim 1, wherein the fuel cell stack is adapted to apply approximately the same load to each of the fuel cells in the fuel cell stack regardless of whether or not the voltage-determining assembly is configured to establish an electrical connection between the first and the second fuel cell subassemblies.

12. The fuel cell system of claim 1, wherein the voltage-determining assembly includes a jumper that is selectively electrically connected with the first and the second fuel cell subassemblies.

13. The fuel cell system of claim 12, wherein the voltage-determining assembly is selectively configured between a first configuration, in which the voltage-determining assembly establishes an electrical connection between the first and the second fuel cell subassemblies, and a second configuration, in which the voltage-determining assembly does not establish an electrical connection between the first and the second fuel cell subassemblies, and further wherein the voltage-determining assembly is adapted to be configured from the first configuration to the second configuration by removal of the jumper.

14. The fuel cell system of claim 1, wherein the voltage-determining assembly includes a switch that is selectively configured between at least a first configuration, in which the switch enables the voltage-determining assembly to establish an electrical connection between the first and the second fuel cell subassemblies, and a second configuration, in which the switch does not form a portion of an electrical connection between the first and the second fuel cell subassemblies.

15. The fuel cell system of claim 14, wherein the switch is a manual switch.

16. The fuel cell system of claim 15, wherein the fuel cell system includes a housing having at least one manually actuated portion in communication with the switch and adapted to receive user inputs configuring the switch between at least the first and the second configurations.

17. The fuel cell system of claim 15, wherein the fuel cell system includes a housing having at least one electrical socket adapted to receive a plug associated with an energy-consuming device that is adapted to exert an applied load to the fuel cell stack; and further wherein the switch is adapted to be automatically configured between at least the first and the second configurations responsive to the predetermined nominal voltage the device is adapted to receive.

18. The fuel cell system of claim 14, wherein the fuel cell system includes a housing having at least a first electrical socket adapted to receive a plug associated with an energy-consuming device that is adapted to receive a power output at the first predetermined nominal voltage, and at least a second electrical socket adapted to receive a plug associated with an energy-consuming device that is adapted to receive a power output at the second predetermined voltage, and further wherein the switch is adapted to be configured between at least the first and the second configurations responsive to whether or not a plug is inserted into the first electrical socket.

19. The fuel cell system of claim 18, wherein the housing includes a restriction device adapted to prevent plugs from being inserted into both the first and the second electrical sockets.

20. The fuel cell system of claim 14, wherein the switch is adapted to retain its configuration regardless of the load applied to the fuel cell stack.

21. The fuel cell system of claim 14, wherein the switch is not configured to switch between the first and the second configurations responsive to the load applied to the fuel cell stack.

22. The fuel cell system of claim 18, wherein the housing includes at least one indicator adapted to provide a visual indication of the nominal voltage of the power output that the fuel cell stack is configured to provide.

23. The fuel cell system of claim 1, wherein the fuel cell system further includes a fuel processing assembly adapted to produce the fuel for the fuel cell stack.

24. The fuel cell system of claim 1, wherein each of the fuel cell subassemblies includes the same number of fuel cells.

25. The fuel cell system of claim 1, wherein the partition is a first partition, wherein the fuel cell stack further includes at least a second partition, with the first and the second partitions dividing the plurality of fuel cells into first, second, and third fuel cell subassemblies that each include a plurality of electrically interconnected fuel cells, and further wherein the fuel cell stack includes at least a second voltage-determining assembly adapted to selectively establish an electrical connection between the second fuel cell subassembly and the third fuel cell subassembly.
